(19) United States
(12) Patent Application Publication
(10) Pub. No.: US 2013/0229143 A1
(43) Pub. Date: Sep. 5, 2013

(54) MULTI-PARTY COMMUNICATION CONTROL SYSTEM AND CHARGE PROCESS OF DC CHARGING SYSTEM

(71) Applicants: SHEAN-KWANG CHOU, New Taipei City (TW); Ying-Chao Liao, New Taipei City (TW); Hung-Gsi Lin, New Taipei City (TW); Chih-Hung Lin, New Taipei City (TW); Sheng-Hua Chen, New Taipei City (TW); Hsiao-Yu Hsu, New Taipei City (TW); Ming-En Fang, New Taipei City (TW); Kai-Ping Hsu, New Taipei City (TW); Wen-Hua Pan, New Taiwan City (TW)

(72) Inventors: SHEAN-KWANG CHOU, New Taipei City (TW); Ying-Chao Liao, New Taipei City (TW); Hung-Gsi Lin, New Taipei City (TW); Chih-Hung Lin, New Taipei City (TW); Sheng-Hua Chen, New Taipei City (TW); Hsiao-Yu Hsu, New Taipei City (TW); Ming-En Fang, New Taipei City (TW); Kai-Ping Hsu, New Taipei City (TW); Wen-Hua Pan, New Taiwan City (TW)

(73) Assignee: Ship and Ocean Industries R&D Center, New Taipei City (TW)

(21) Appl. No.: 13/417,239

(22) Filed: Mar. 10, 2012

(30) Foreign Application Priority Data
Mar. 2, 2012 (TW) 101106883

(51) Int. Cl. H02J 7/00

(52) U.S. Cl. 320/107

(57) ABSTRACT

A multi-party communication control system and charge process of a DC charging system is provided. According battery pack information transmitted by a battery control system, a multi-party communication control device determines a charge current or a charge voltage and a voltage-controlled charge mode required by a battery pack. The multi-party communication control device then translates the charge voltage or the charge current to a CHAdeMO language that is next transmitted to a CHAdeMO charger.

### BACKGROUND

1. Field of the Invention

The present invention relate in general to a direct-current (DC) charge system, and more particularly to a multi-party communication control system and charge process of a DC charge system.

2. Description of the Related Art

The CHAdeMO (Charge de Move, or Charge for Moving) specification is a prevalent fast DC charging standard applied to vehicles. A CHAdeMO system utilizes a control device area network (CAN) bus as a main communication interface for vehicles, whereas in vessel systems, RS-485 is utilized as a main communication interface. Therefore, to apply CHAdeMO to a vessel system, a language translating system is required for translating languages between a CHAdeMO system and a vessel system, so as to communicate with and charge a battery pack of a vessel. However, as being time-consuming and effort-consuming, the language translation processes of or modifications made to different languages between languages of different types of battery packs are not only cost-ineffective but also significantly degrade utilization conveniences of a battery pack. Further, when implementing a CHAdeMO system to a powered off vehicle, it is necessary that the vehicle be first powered on in order to charge the vehicle. The above step of additionally powering on the vehicle again adds to complications to the charging process as well as power consumption of the vehicle.

### SUMMARY

The present invention provides a multi-party communication control system of a direct-current (DC) charge system. The multi-party communication control system includes a multi-party communication control device, a relay, and a charge dock. The charge dock is compliant to the CHAdeMO specifications. The multi-party communication control device communicates with a battery control system of a vessel through a CAN bus or an RS-485 interface, and selects a charge voltage or a charge current and a voltage-controlled charge mode required by a battery pack according to battery pack information transmitted from the battery management system. The multi-party communication control device further translates the charge voltage or the charge current to a language adopted by a CHAdeMO charger, and transmits the translated language to the CHAdeMO charger to start charging. As the charge process begins, the multi-party communication control device activates the relay, so as to allow the CHAdeMO charger to charge the battery pack by the charge dock via the relay.

The present invention further provides a charge process of a multi-party communication control system of a DC charge system. It is first determined whether a vessel accelerator is at a parking gear, and it is determined whether a charge plug of a CHAdeMO charger is plugged to a charge dock. According to battery pack information, a multi-party communication device selects a charge voltage or a charge current and a voltage-controlled charge mode required by a battery pack. The multi-party communication device further translates the charge voltage or the charge current to a language adopted by the CHAdeMO charger, and transmits the translated language to the CHAdeMO charger via the charge dock. The CHAdeMO charger determines whether an activation button is pressed, and the multi-party communication device activates a relay to start charging when the activation button is pressed. During the charge process, the multi-party communication device continues to receive the battery pack information transmitted by a battery management system to determine whether an abnormality is present and whether charging is complete. The CHAdeMO charger further determines whether an emergency stop button is pressed. In the event of that the abnormality is present, the emergency stop button is pressed or charging is complete, the relay is turned off to end the charge process.

Through the multi-party communication control system and charge process for a DC charge system, without translations or modifications for a language adopted by a battery pack, significant costs are saved while communication and charging with a CHAdeMO charger can be easily performed. Further, a central control system of a vessel communicates with the multi-party communication control device via an RS-485 communication interface, and monitors as well as stores information of the voltage, current, temperature and remaining electric power of the battery pack to in real-time monitor a current status of the battery pack. Therefore, the central control system does not directly control the charge process, and the charge process can still be performed when the central control system is powered off.

### BRIEF DESCRIPTION OF THE DRAWINGS

FIG. 1 is a schematic diagram of a multi-party communication control system of a DC charge system of the present invention.

FIG. 2 is a flowchart of a charge process of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

### First Embodiment

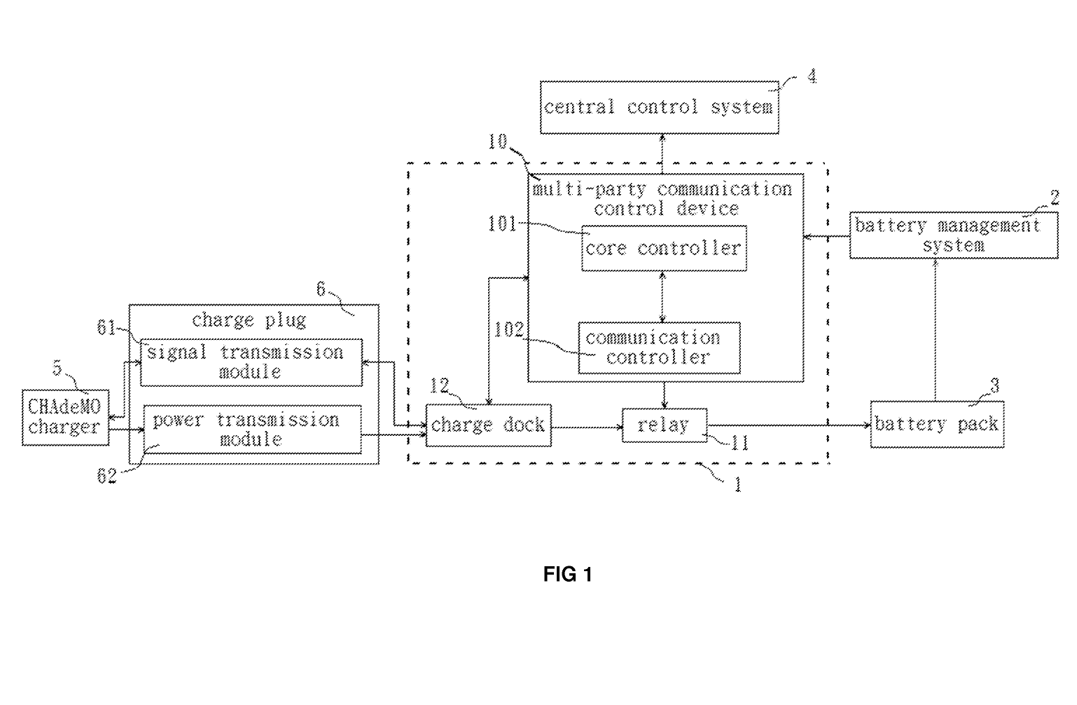

Referring to FIG. 1, a multi-party communication control system 1 of a DC charging system includes a multi-party communication control device 10, a relay 11 and a charge dock 12. The multi-party communication control device 10 includes a core controller 101 and a communication controller 102. For example, the core controller 101 is an industrial computer, a system-on-chip (Soc) or a programmable controller. Via a CAN bus or RS-485 interface, the multi-party communication control device 10 communicates with a battery management system 2. The battery management system 2 in real-time detects a voltage, a current, a temperature and a battery abnormality of a battery pack 3, calculates remaining electric power of the battery pack 3, and transmits detected results every second to the multi-party communication control device 10. When the multi-party communication control system 10 receives the information transmitted from the battery management system 2, the core controller 101 selects charge requirements including a charge voltage or a charge voltage and a voltage-controlled charge mode for the battery pack 3 according to the received information, and translates the charge requirements of the battery pack 3 to a language adopted by a CHAdeMO (Charge de Move, or Charge for Moving) charger 5. The translated charge requirements of the battery pack 3 are then transmitted to the CHAdeMO charger 5 through the charge dock 12 via a CAN bus to perform charging.

A central control system 4 communicates with the multi-party communication control device 10 via an RS-485 communication interface. Through the multi-party communication control device 10, the central control system 4 monitors and stores information of the voltage, current, temperature and remaining electric power of the battery pack 3 during the charge process, so as to in real-time monitor a current status of the battery pack 3. It should be noted that, the central control system 4 does not directly control the charge process, and so the charge process can still be performed when the central control system 4 is powered off.

The relay 11 is controlled by the multi-party communication control device 10. Upon receiving a message indicating that the CHAdeMO charger 5 is activated through the charge dock 12, the multi-party communication control device 10 activates the relay 11 to start charging. The multi-party communication control device 10 turns off the relay 11 to end the charging process when the multi-party communication control device 10 determines that the charging is completed.

The charge dock 12 is connected to a charge plug 6 of the CHAdeMO charger 5. The charge plug 6 includes a signal transmission module 61 and a power transmission module 62. Through the charge dock 12, the CHAdeMO charger 5 communicates with the signal transmission module 61 and mutually exchanges current charge information every 100 ms. The CHAdeMO charger 5 is further connected to relay 11 through the power transmission module 62 to perform charging.

### Second Embodiment

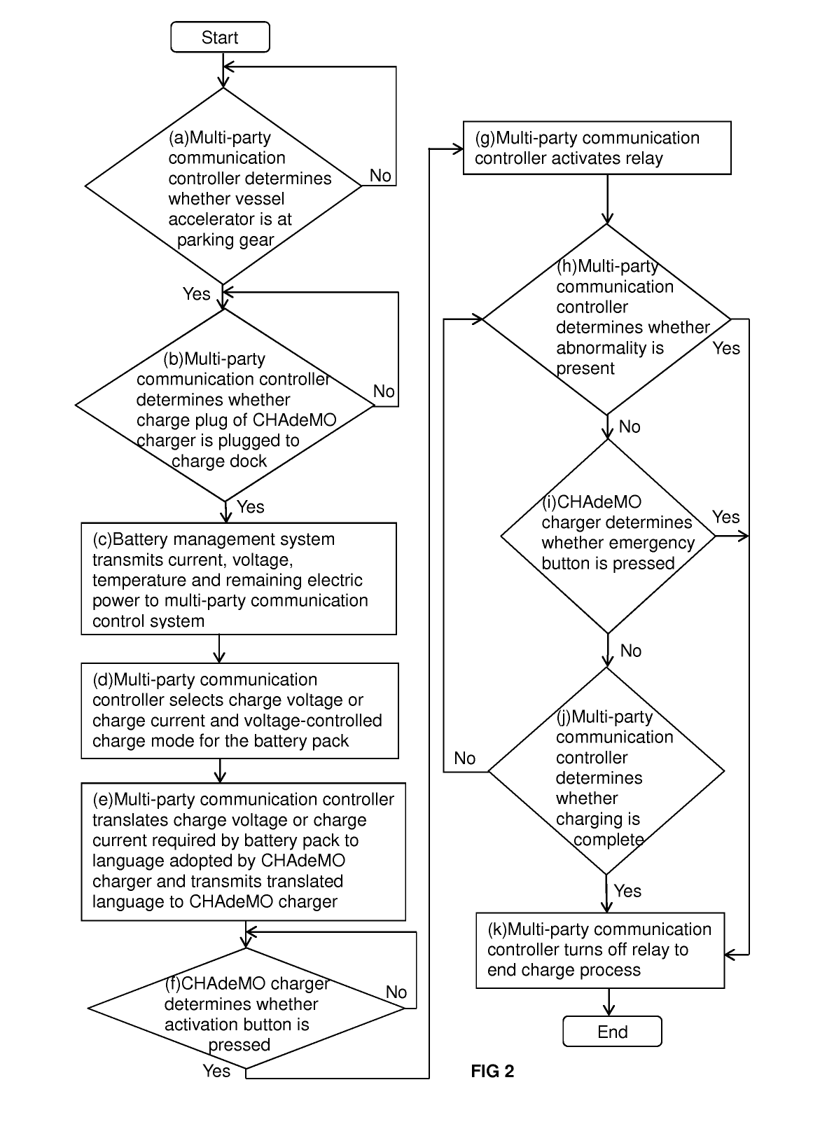

FIG. 2 shows a flowchart of a charge process of the multi-party communication control system 1 for a DC charge system. The process includes steps below.

In Step (a), the multi-party communication control device 10 determines whether a vessel accelerator is at a parking gear. Step (b) is performed when a determination result is affirmative, or else the process iterates Step (a). In Step (b), the multi-party communication control device 10 determines whether the charge plug 6 of the CHAdeMO charger 5 is plugged to the charge dock 12. Step (c) follows when a determination result is affirmative, or else the process iterates Step (b). In Step (c), the battery management system 2 transmits information of current, voltage, temperature and remaining electric power of the battery pack 3 to the multi-party communication control device 10. The charge process next performs Step (d).

In Step (d), the multi-party communication control device 10 selects a charge voltage or a charge current and a voltage-controlled charge mode for the battery pack 3. With respect to the voltage-control charge mode, a constant-current charge mode is used when a voltage of at least one battery of the battery pack 3 is lower than 4.1V, and a constant-voltage charge mode is used when the voltage of the at least one battery of the battery pack 3 is higher than 4.1V.

In Step (e), the multi-party communication control device 10 translates the charge voltage or the charge current required by the battery pack 3 to a language adopted by the CHAdeMO charger 5, and transmits the translated language to the CHAdeMO charger 5.

In Step (f), the CHAdeMO charger 5 determines whether an activation button is pressed. In Step (g), the multi-party communication control device 10 powers on the relay 11. In Step (h), the multi-party communication control device 10 determines whether an abnormality is present. The process proceeds to Step (k) when an abnormality is present, or else Step (i) is performed. For example, the abnormality includes a battery abnormality and a charging abnormality. The battery abnormality includes an over-voltage, an over-current, an over-temperature and/or a leakage current. For example, the charging abnormality includes a mismatch between an actual charge voltage and current and the required charge voltage and current, a reception failure of signals from the battery management system 2 to the multi-party communication control device 10 for over five seconds, and a reception failure of mutual signals of the multi-party communication control device 10 and the CHAdeMO charger 5 for over one second.

In Step (i), the CHAdeMO charger 5 determines whether an emergency stop button is pressed. In Step (j), the multi-party communication control device 10 determines whether the charging is complete. In Step (k), the multi-party communication control device 10 turns off the relay 11 to end the charge process.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A multi-party communication control system for a direct-current (DC) charge system, comprising:
a multi-party communication control device, for selecting a charge voltage, a charge current and a voltage-controlled charge mode, and translating and exchanging languages adopted by a controller area network (CAN) bus and an RS-485 interface;
a relay, connected to the multi-party communication control device, for activating and inactivating charging of a battery pack; and
a charge dock, connected to the relay and the multi-party communication control system, for connecting to a charge plug.

2. The system according to claim 1, wherein the multi-party communication control device comprises a core controller and a communication controller.

3. The system according to claim 2, wherein the core controller is an industrial computer, a chip or a programmable controller.

4. The system according to claim 1, wherein the multi-party communication device communicates with a CHAdeMO (Charge de Move, or Charge for Moving) charger via the CAN bus, communicates with a battery management system via the RS-485 communication interface, and communicates with a central control system via the RS-485 communication interface.

5. The system according to claim 4, wherein the battery management system detects a voltage, a current, a temperature, remaining electric power and a battery abnormality of the battery pack, and transmits detected results to the multi-party communication control device.

6. The system according to claim 4, wherein the central control system monitors and records a voltage, a current, a temperature and remaining electric power of the battery pack.

7. The system according to claim 5, wherein the battery abnormality comprises an over-voltage, an over-current, an over-temperature and a leakage current.

8. The system according to claim 4, wherein the battery management system transmits a latest battery status every second to the multi-party communication control device.

9. The system according to claim 4, wherein the multi-party communication control device and the CHAdeMO charger exchange current charge status information every 100 ms as the charge process begins.

10. The system according to claim 1, wherein the charge plug is connected to the CHAdeMO charger.

11. A charge process of a multi-party communication control device for a DC charge system, comprising:
a) by a multi-party communication control device, determining whether a vessel accelerator is in a parking gear, and performing Step (b) when a determination result is affirmative, or else iterating Step (a);
b) by the multi-party communication control device, determining whether a charge plug of a CHAdeMO (Charge de Move, or Charge for Moving) charger is plugged to a charge dock, and performing Step (c) when a determination result is affirmative, or else iterating Step (b);
c) by a battery management system a current, transmitting a voltage, a temperature and remaining electric power of a batter pack to the multi-party communication control device;
d) by the multi-party communication control device, selecting a charge voltage or a charge current and a voltage-control charge mode for the battery pack;
e) by the multi-party communication control device, translating the charge voltage or the charge current required by the battery pack to a language adopted by the CHAdeMO charger, and transmitting the translated language to the CHAdeMO charger;
f) by the CHAdeMO charger, determining whether an activation button is pressed;
g) by the multi-party communication control device, activating a relay;
h) by the multi-party communication control device, determining whether an abnormality is present;
i) by the CHAdeMO charger, determining whether an emergency stop button is pressed;
j) by the multi-party communication control device, determining whether charging is complete; and
k) by the multi-party communication control device, turning off the relay to end the charge process.

12. The charge process according to claim 11, wherein the voltage-control charge mode in Step (d) is a constant-current charge mode when a voltage of at least one battery of the battery pack is lower than 4.1V, and is a constant-voltage charge mode when the voltage of the at least one battery of the battery pack is higher than 4.1V.

13. The charge process according to claim 11, wherein the abnormality in Step (h) comprises a battery abnormality and a charging abnormality.

14. The charge process according to claim 13, wherein the battery abnormality comprises an over-voltage, an over-current, an over-temperature and a leakage current.

15. The charge process according to claim 13, wherein the charging abnormality is determined as present when a mismatch between an actual charge voltage and current and the required charge voltage and current occurs.

16. The charge process according to claim 13, wherein the charging abnormality is determined as present when a reception failure of signals from the battery management system to the multi-party communication control device occurs for over five seconds.

17. The charge process according to claim 13, wherein the charging abnormality is determined as present when a reception failure of mutual signals of the multi-party communication control device and the CHAdeMO charger occurs for over one second.
